(19) United States
(12) Patent Application Publication
(10) Pub. No.: US 2008/0176071 A1
(43) Pub. Date: Jul. 24, 2008

(54) Single wall carbon nanotubes with surfactant-coated surface and process for preparing the same

(76) Inventors: Sung-Min Choi, Yuseong-ku (KR); Changwoo Doe, Yuseong-ku (KR); Tae-Hwan Kim, Yuseong-ku (KR)

Correspondence Address: NATH & ASSOCIATES, 112 South West Street, Alexandria, VA, 22314, US

(21) Appl. No.: 11/979,469

(22) Filed: Nov. 2, 2007

(30) Foreign Application Priority Data
Nov. 3, 2006 (KR) 10-2006-0108601

(51) Int. Cl. B06B 1/20; B32B 27/06

(52) U.S. Cl. 428/368; 427/601

(57) ABSTRACT

Disclosed are a process for preparing single wall carbon nanotubes with surfactant-coated surface which comprises coating a surface of the carbon nanotubes with a surfactant by adding water to a mixture of the carbon nanotubes and the surfactant, ultrasonically treating the mixture, treating the ultrasonically treated mixture with a initiator, and applying a surfactant to the surface of the resultant carbon nanotubes and, in addition, the carbon nanotubes with surfactant-coated surface prepared by the above process. The formed carbon nanotubes of the present invention can maintain a stable dispersion condition regardless of change of an external environment and be stably dispersed in water even when putting the carbon nanotubes into the water after completely drying the same, so that the carbon nanotubes can be widely used in developing and manufacturing various products.

This application claims priority to Korean Patent Application No. 2006-0108601, filed on Nov. 3, 2006, in the Korean Intellectual Property Office, the entire contents of which are hereby incorporated by reference.

### BACKGROUND OF THE INVENTION

1. Field of the Invention

The present invention relates to single wall carbon nanotubes with surfactant-coated surfaces and processes for preparing the same, more particularly, to a process for preparing single wall carbon nanotubes with surfactant-coated surface which comprises coating a surface of the carbon nanotubes with a surfactant by adding water to a mixture of the carbon nanotubes and the surfactant, ultrasonically treating the mixture, treating the ultrasonically treated mixture with a initiator, and applying the surfactant to the surface of the resultant carbon nanotubes and, in addition, the single wall carbon nanotubes with surfactant-coated surface produced by the above process.

2. Description of the Related Art

Single wall carbon nanotubes (hereinafter often referred to as “SWNTs”) which are usually called carbon nanotubes, are employed in various applications including, for example, molecular dimension electronic materials, nano-sized polymers, energy storage devices, reinforced nano structures, etc. on the basis of mechanical, electrical and thermal properties thereof, and applications thereof are now increasing. However, in order to adapt or use the carbon nanotubes, it is needed to disperse isolated carbon nanotubes in an aqueous solution.

Recently, techniques for dispersing the carbon nanotubes in aqueous solutions have been developed, for example, which include: a nanotube dispersion method comprising adsorption of a surfactant around the nanotubes (see, Nano Lett., 2:269-273, 2003); a nanotube dispersion method using a hydrophilic polymer (see, Macromolecules, 32:2569-2576, 1999); a nanotube dispersion method using bio-materials such as DNA (see, Science, 302:1545-1548, 2003), etc. However, the carbon nanotube dispersion obtained by any one of the above methods had a defect in that the dispersion may become coagulated again dependent on change of an external environment due to dynamic properties of self-assembled structure of the dispersion. For instance, the nanotube dispersion may be again coagulated when the surfactant adsorbed around the nanotubes is released from the nanotubes.

Accordingly, there is a constant demand to develop novel carbon nanotubes capable of being dispersed without re-coagulation regardless of the changes of the external environment.

### SUMMARY OF THE INVENTION

After extensive research and investigation to develop carbon nanotubes capable of being continuously dispersed without re-coagulation regardless of the change of the external environment, the present inventors have found that carbon nanotubes with surfactant-coated surface are possibly formed by adsorbing the surfactant to the carbon nanotubes, dispersing the treated carbon nanotubes and coating the surface of the carbon nanotubes with the surfactant, so as to stably retain the dispersible condition regardless of the change of the external environment and also to be stably re-dispersed in the water even when the carbon nanotubes are put into the water after completely drying the same, and as a result, successfully accomplished the present invention.

Accordingly, an object of the present invention is to provide carbon nanotubes which are dispersible in an aqueous solution without re-coagulation.

Another object of the present invention is to provided a process for preparing the above carbon nanotubes.

The present inventors studied and investigated to develop a novel method for preventing re-coagulation of carbon nanotubes regardless of the change of the external environment and noticed that the surfactant treated carbon nanotubes are re-coagulated due to removal of the surfactant from the carbon nanotubes. Thus, it was assumed that the carbon nanotubes would not be re-coagulated if the surfactant is not released from the carbon nanotubes regardless of the changes of the external environment.

Accordingly, in order to prevent the removal of the surfactant from the carbon nanotubes, the present inventors studied and discussed a lot of technical skills and approaches and found that the surfactant was not removed from the carbon nanotubes regardless of the change of the external environment, by coating the carbon nanotubes with the surfactant.

In order to identify the above findings, absorbance and dispersion properties in UV-vis-NIR region of carbon nanotubes were determined. Herein, the carbon nanotubes were SWNTs with surfactant-coated surface and other SWNTs formed by drying the SWNTs with surfactant-coated surface then re-dispersing the dried SWNTs, in comparison with those of SWNTs with surfactant-coated surface without drying. As a result of determining and comparing the absorbance values and the dispersion properties of both of SWNTs, it was observed that the measured values of both SWNTs were substantially equal to each other indicating that the SWNTs remained as isolated forms even after drying and re-dispersing process. Even if each of the SWNTs was left for about three months, it was certain that the dispersion properties are substantially at the same level with those before the SWNTs were left.

Accordingly, the present invention is directed to solve the above problems and, an object of the present invention is to provide a process for preparing carbon nanotubes with surfactant-coated surface.

In an aspect of the present invention, the process for preparing the carbon nanotubes with surfactant-coated surface comprises: (i) blending the carbon nanotubes and a surfactant in a ratio by weight of 1:2 to 2:5 (w/w) and eliminating oxygen (O₂); (ii) mixing the blend of step (i) with O₂-free water in a ratio by volume of 0.7:100 to 0.8:100 (v/v), ultrasonically treating the mixture at frequency of 15 to 20 kHz for 1 to 1.5 hours to disperse the carbon nanotubes in the water; and (iii) adding 1 to 5% by mole of a initiator to the dispersion of step (ii) to coat a surface of the carbon nanotubes with the surfactant while agitating the dispersion at 55 to 65° C. for 12 to 24 hours.

With regard to the above process according to the present invention, the carbon nanotubes are not particularly limited to, but preferably include single wall carbon nanotubes (SWNTs). The surfactant is particularly limited to, but preferably includes cetyltrimethyl ammonium 4-vinylbenzoate (CTVB). The initiator is not particularly limited to, but preferably includes 2,2′-azobis [2-(2-imidazolin-2-yl)propane]dihydrochloride.

In step (i), when the mixing ratio of the carbon nanotubes and the surfactant is less than 2:1(w/w), the reaction yield is decreased due to an excessive amount of the surfactant. Whereas, if the mixing ratio exceeds 5:2(w/w), the carbon nanotubes are not sufficiently coated with the surfactant due to lack of the amount of the surfactant.

In step (ii), in order to desirably disperse the carbon nanotubes in the water, the mixing ratio of the water to the carbon nanotubes and conditions of the ultrasonic treatment are substantially the same to those commonly known in the related art. See M. J. O'Connell, Science, 297:593, 2002; M. J. O'Connell, Nano. Lett, 3:269, 2003, which is hereby incorporated by reference in its entirety.

In step (iii), an amount of the initiator added to the dispersion for the coating reaction of the surfactant is substantially equal to that well known in the related art. See S. R. Kline, Langmuir, 15:2726, 1999; T. H. Kim, et al., Langmuir, 22:2844, 2006, each of which is hereby incorporated by reference in its entirety.

In a case where the initiator is added to the dispersion and the reaction is conducted at a temperature less than 55° C., the carbon nanotubes are not sufficiently coated with the surfactant. On the other hand, if the reaction is conducted at a temperature higher than 65° C., the coating efficiency of the surfactant to the carbon nanotubes is reduced. Alternatively, when the reaction proceeds for less than 12 hours, the surfactant coating layers are not sufficiently fixed by the polymerization process. In addition, since the coating and polymerization of the coating layers of the carbon nanotubes does not continue even if the reaction time exceeds 24 hours, an extension of the reaction time is quite unnecessary.

Moreover, the reaction product after completion of the coating reaction contains uncoated CTVB in a significant amount other than SWNTs with CTVB-coated surface. Therefore, in order to separate and purify only SWNTs with CTVB-coated surface from the reaction product, the inventive process further comprises a step of centrifuging the reaction product at 100,000 to 150,000×g for 3 to 5 hours, obtaining a supernatant from the centrifuged product and drying the supernatant following step (iii) for coating the carbon nanotubes.

As described above, the carbon nanotubes with surfactant-coated surface according to the present invention can maintain a stable dispersion condition regardless of the change of the external environment and be stably dispersed in water even when putting the carbon nanotubes into the water after completely drying the same, so that the carbon nanotubes can be widely used in developing and manufacturing various products.

Features of the present invention described above and other advantages will be more clearly understood by the following non-limited examples, which are not intended to restrict the scope of the invention but are instead illustrative embodiments of the present invention.

### BRIEF DESCRIPTION OF THE DRAWINGS

These and other objects, features, aspects, and advantages of the present invention will be more fully described in the following detailed description for preferred embodiments and examples, taken in conjunction with the accompanying drawings. In the drawings:

FIG. 1 is spectra illustrating NMR analysis results for several coating reaction products, each of which consists of SWNTs and a surfactant (especially, CTVB);

FIG. 2 is a schematic view illustrating a whole process for preparing SWNTs with surfactant-coated surface according to the present invention;

FIG. 3 is a spectrum illustrating absorbance in UV-vis-NIR region of SWNTs with surfactant-coated surface, which were re-dispersed in water after drying SWNTs as an experimental embodiment of the present invention, compared to that of SWNTs with surfactant-coated surface without drying treatment as a control;

FIG. 4A is a graph illustrating dispersion properties of SWNTs as the embodiment shown in FIG. 3 which were determined using SANS equipment, compared to those of SWNTs with surfactant-coated surface as the control, immediately after obtaining each of SWNTS; and

FIG. 4B is a graph illustrating dispersion properties of SWNTs as the embodiment shown in FIG. 3 which were determined using SANS equipment, compared to those of SWNTs with surfactant-coated surface as the control, three months after obtaining each of SWNTs.

### DETAILED DESCRIPTION OF THE INVENTION

Hereinafter, the present invention will become apparent from the following examples with reference to the accompanying drawings. However, these are intended to illustrate the invention as preferred embodiments of the present invention and do not limit the scope of the present invention.

### EXAMPLE 1

### Preparation of Carbon Nanotubes with Surfactant-Coated Surface

First of all, in order to prepare O₂-free water, a vial was filled with distilled water and sealed using a rubber cap, followed by fitting two injection needles into the rubber cap. After that, nitrogen gas (N₂) was introduced through one of the needles into the vial while exhausting air bubbles pushed out of the vial by N₂ inflow. After introducing N₂ for 30 minutes, the O₂-free water was obtained by taking the needles out of the rubber cap.

Next, 2 g of SWNTs with 98% purity (CNI Co., USA) was mixed with 5 g of a surfactant named, cetyltrimethylammonium 4-vinylbenzoate (CTVB) which was produced by a commonly known synthesis process (Langmuir, 22:2844-2850, 2006, see supra.) and the mixture was placed in another vial. This mixture was subjected to removal of O₂ contained in the vial by the same procedure as described above.

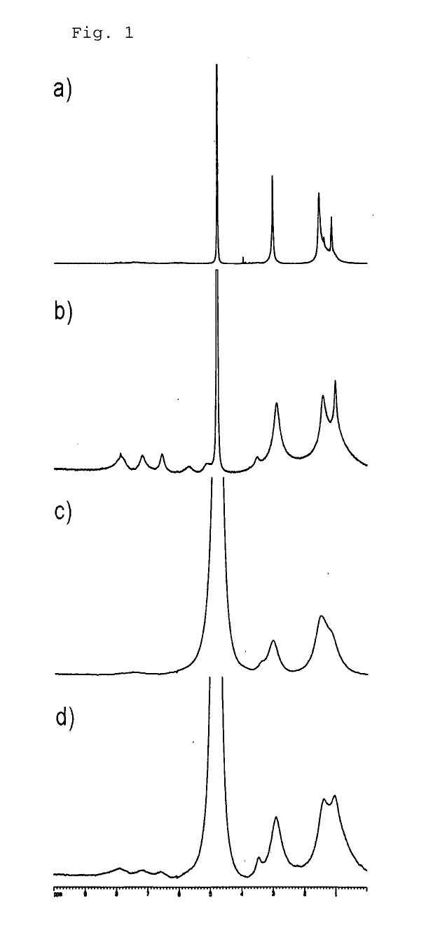

By using another needle, 1 liter of the O₂-free water prepared as described above was introduced into the vial in which the mixture of SWNTs and CTVB is already included. Subsequently, the vial was placed in a cup-horn type sonicator (VCX750, Cole Palmer Co., USA) and subjected to ultrasonic treatment at 20 kHz for 1 hour by applying 500 W of power to the vial. To the treated vial, was added VA-044 (2,2′-azobis[2-(2-imidazolin-2-yl)propane]dihydrochloride) available from Sigma Chem. Co., USA, in a molar ratio of 5% and stirred for one day to produce SWNTs with CTVB-coated surface. Thereafter, the produced SWNTs with CTVB-coated surface underwent NMR analysis (Bruker NMR FT-500 MHz) and a result determined by the NMR analysis was compared with each of results determined by NMR analysis for coated CTVB, uncoated CTVB and SWNTs with CTVB-uncoated surface, as shown in FIG. 1.

FIG. 1 is spectra illustrating NMR analysis results of the coating reaction products, each of which consists of SWNTs and a surfactant (especially, CTVB). More particularly, a) is NMR analysis result of the coated CTVB, b) is NMR analysis result of the uncoated CTVB, c) is NMR analysis result of SWNTs with CTVB-coated surface, and d) is NMR analysis result of SWNTs with CTVB-uncoated surface. As shown in FIG. 1 b) and d), it was observed that CTVB has peaks of vinyl groups and benzene rings presented between 5 ppm and 8 ppm. On the other hand, the coated reaction products shown in FIG. 1 a) and c) did not display the peaks. This is because activity or molecular mobility of the surfactant is reduced and, in turn, T2 relaxation time becomes shortened by coating the surface of the carbon nanotubes with the surfactant, thereby indicating successful completion of the coating reaction.

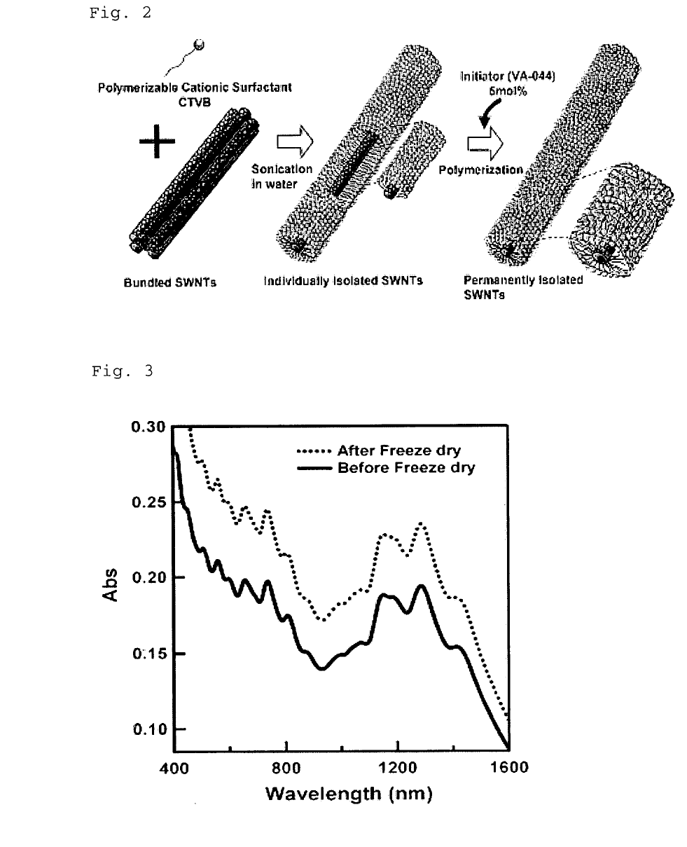

Furthermore, the reaction product after the completion of the coating reaction contains the uncoated CTVB in a significant amount other than SWNTs with CTVB-coated surface. Therefore, in order to separate and purify only SWNTs with CTVB-coated surface from the reaction product, the reaction product was further subjected to centrifugation at 110,000×g for 4 hours. Later, an aliquot of about 60% by volume of a supernatant of the centrifuged product was taken using a pipette and dried to produce the resultant carbon nanotubes with surfactant-coated surface. See, FIG. 2.

FIG. 2 is a schematic view illustrating the whole process for preparing SWNTs with surfactant-coated surface according to the present invention.

### EXAMPLE 2

### Determination of Dispersion Stability of Carbon Nanotubes with Surfactant-Coated Surface

The carbon nanotubes with surfactant-coated surface prepared in Example 1 have a beneficial feature in that a CTVB layer surrounding SWNTs is securely fixed thereto and is not destroyed even under severe environmental variation.

Accordingly, it was expected that the produced carbon nanotubes may have a favorable dispersion condition substantially the same as the original condition thereof by completely evaporating a liquid portion of the dispersion to obtain P-SWNTs in a dried solid condition and placing the P-SWNTs in water while only shaking the solution for about 10 minutes. In order to demonstrate the above presumption, the following procedure was performed:

At the beginning, two samples were prepared: the carbon nanotubes with surfactant-coated surface prepared in Example 1 as a control; and the carbon nanotubes with re-dispersed surfactant-coated surface as an experimental sample, which was prepared by lyophilizing the carbon nanotubes with surfactant-coated surface (that is, the control) to form a solid portion and dispersing the solid portion in water.

Next, both of the control and the experimental sample underwent determination of absorbance in UV-vis-NIR region by using a spectrometer Jasco V-570 (Jasco Co., USA). See, FIG. 3.

FIG. 3 is a graph illustrating absorbance in UV-vis-NIR region of each of the control and the experimental sample. A blue line is for the control while the red line displays the experimental sample. As shown in FIG. 3, there was little difference in the determined absorbances in US-vis-NIR region between the control and the experimental sample.

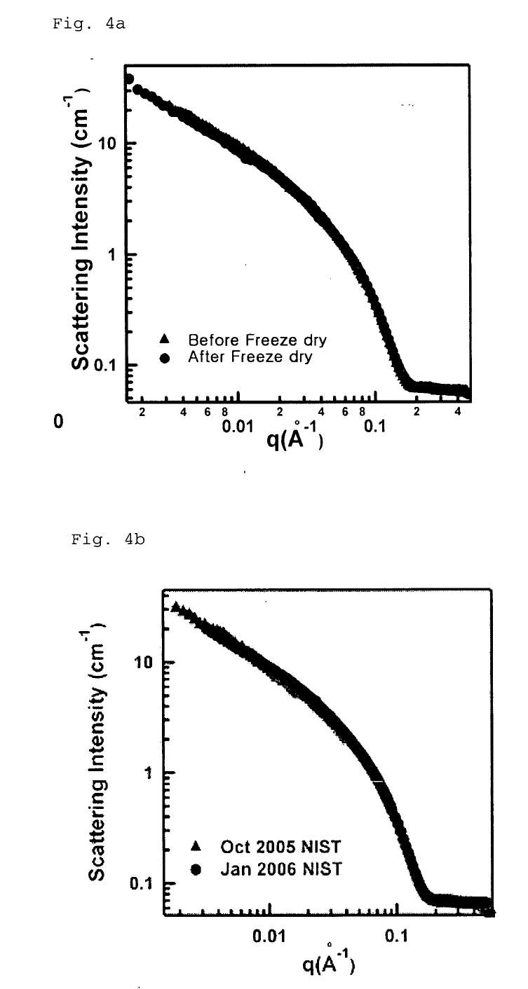

Alternatively, dispersion properties of the control and the experimental sample were compared to each other by using small angle neutron scattering equipment (SANS, available at the NG7 beam line of NIST in the USA), immediately after and three months after preparing each of the control and the experimental sample. Herein, the dispersion properties were determined in the area of 0.0015 Å⁻¹<q<0.5368 Å⁻¹ at a neutron beam wavelength of 6 wherein q represents (4 π/λ) sin(θ/2) with the neutron beam wavelength of λ and the scattering angle of θ. See, FIGS. 4A and 4B.

FIG. 4A is a graph illustrating the dispersion properties of the control and the experimental sample which were determined using the SANS equipment, immediately after preparing each of the control and the experimental sample. Likewise, FIG. 4B is a graph illustrating the dispersion properties of the control and the experimental sample which were determined using the SANS equipment three months after preparing each of the control and the experimental sample.

As shown in FIGS. 4A and 4B, it was found that each of the control and the experimental sample has substantially the same dispersion properties, three months after the preparation as well as just after the preparation thereof.

On the basis of the above results, it was understood that the carbon nanotubes with surfactant-coated surface of the present invention which were re-dispersed after drying, have the dispersion properties substantially the same as those before the drying process and these were not altered with the lapse of time. Consequently, it was proved that the present inventive carbon nanotubes have excellent dispersion properties clearly distinguished from those of conventional carbon nanotubes.

As described in detail above and identified from the results of the examples, the present invention provides a process for preparing carbon nanotubes with surfactant-coated surface which comprises: coating the surface of the carbon nanotubes with the surfactant by adding water to a mixture of the carbon nanotubes and the surfactant; ultrasonically treating the mixture; treating the ultrasonically treated mixture with a initiator; and applying a surfactant to a surface of the resultant carbon nanotubes and, in addition, the carbon nanotubes with surfactant-coated surface prepared by the above process. The formed carbon nanotubes of the present invention can maintain a stable dispersion condition regardless of the change of the external environment and be stably dispersed in water even when putting the carbon nanotubes into the water after completely drying the same, so that the carbon nanotubes can be widely used in developing and manufacturing various products.

While the present invention has been described with reference to the preferred embodiments and examples, it will be understood by those skilled in the art that various modifications and variations may be made therein without departing from the scope of the present invention as defined by the appended claims.

What is claimed is:

1. A process for preparing carbon nanotubes with surfactant-coated surface, comprising: (i) blending the carbon nanotubes and a surfactant in a ratio by weight of 1:2 to 2:5 (w/w) and eliminating oxygen (O₂); (ii) mixing the blend of step (i) with O₂-free water in a ratio by volume of 0.7:100 to 0.8:100 (v/v) and ultrasonically treating the mixture at frequency of 15 to 20 kHz for 1 to 1.5 hours to disperse the carbon nanotubes in the water; and (iii) adding 1 to 5% by mole of a initiator to the dispersion of step (ii) to coat a surface of the carbon nanotubes with the surfactant while agitating the dispersion at 55 to 65 □ for 12 to 24 hours.

2. The process according to claim 1, wherein the carbon nanotubes comprise single wall carbon nanotubes (SWNTs) with surfactant-coated surface.

3. The process according to claim 1, wherein the surfactant comprises cetyltrimethylammonium 4-vinylbenzoate (CTVB).

4. The process according to claim 1, wherein the initiator comprises 2,2′-azobis[2-(2-imidazolin-2-yl)propane]dihydrochloride.

5. The process according to claim 1, further comprising: a step of centrifuging the reaction product at 100,000 to 150,000×g for 3 to 5 hours, obtaining a supernatant from the centrifuged product and drying the supernatant following step (iii) for coating the carbon nanotubes.

6. Carbon nanotubes with surfactant-coated surface prepared by the process defined in claim 1.
